(19) United States
(12) Patent Application Publication
(10) Pub. No.: US 2009/0241151 A1
(43) Pub. Date: Sep. 24, 2009

(54) SYSTEMS AND METHODS FOR REMOTELY CONTROLLING A CONSUMER DEVICE

(75) Inventors: Jonathan A. FRANK, Aurora, CO (US); Max S. GRATTON, Lakewood, CO (US)

Correspondence Address: INGRASSIA FISHER & LORENZ, P.C. (DISH), 7010 E. COCHISE ROAD, SCOTTSDALE, AZ, 85253-1406, US

(73) Assignee: DISH NETWORK L.L.C., Englewood, CO (US)

(21) Appl. No.: 12/052,945

(22) Filed: Mar. 21, 2008

(51) Int. Cl. H04N 7/173

(52) U.S. Cl. 725/106

(57) ABSTRACT

Systems and methods allow for the remote control of a personal video recorder (PVR), digital video recorder (PVR), set-top box (STB) or other consumer device that is capable of receiving programming via a high-bandwidth connection. A request is received from the customer for an action to be taken by the consumer device, wherein the request is received via a communications channel distinct from the high-bandwidth connection. The consumer device associated with the customer is identified in response to the request, and instruction is transmitted to the consumer device associated with the customer via the high-bandwidth connection to thereby direct the consumer device to carry out the action requested by the customer.

### TECHNICAL FIELD

The present invention generally relates to consumer devices such as set-top boxes (STBs), digital video recorders (DVRs) and/or the like, and more particularly relates to systems and methods for remotely controlling a consumer device using a telephone or other communication device.

### BACKGROUND

Most television viewers now receive their television signals through a content aggregator such as a cable or satellite television provider. In the typical instance, encoded television signals are sent via a cable or wireless data link to the viewer's home, where the signals are ultimately decoded in a set-top box (STB) or other consumer device. The decoded signals can then be viewed on a television or other appropriate display as desired by the viewer.

More recently, personal video recorders (PVRs), also commonly called “digital video recorders” (DVRs), have become commonplace. Like a video cassette recorder (VCR), a PVR/DVR is able to record programs for later viewing by the customer. Many set-top boxes provided by cable or wireless content aggregators now include PVR/DVR functionality, thereby expanding the capabilities of the STB and greatly improving the convenience and service provided to the customer.

Often, however, customers have a need or desire to make changes to their STB or DVR/PVR programming even when they are not in close physical proximity to the device. While a customer is away from home, for example, he or she may think of a program that he or she would like to record. If there is no opportunity to immediately instruct the customer's DVR to record the program, the thought may be lost and the program may not be recorded. Moreover, if the program is scheduled to begin before the customer plans to return to his or her home, the customer may not have an opportunity to record the program at all.

It is therefore desirable to create systems and processes for remotely controlling PVR/DVR, STB and/or other consumer devices. These and other desirable features and characteristics will become apparent from the subsequent detailed description and the appended claims, taken in conjunction with the accompanying drawings and this background section.

### BRIEF SUMMARY

In various embodiments, systems and methods allow for the remote control of a personal video recorder (PVR), digital video recorder (PVR), set-top box (STB) and/or other consumer device that is capable of receiving programming via a high-bandwidth connection. A request is received from the customer for an action to be taken by the consumer device, wherein the request is received via a communications channel distinct from the high-bandwidth connection. The consumer device associated with the customer is identified in response to the request, and instruction is transmitted to the consumer device associated with the customer via the high-bandwidth connection to thereby direct the consumer device to carry out the action requested by the customer.

In other embodiments, a method is provided for directing a consumer device associated with a customer to record a program, wherein the consumer device is capable of receiving programming via a high-bandwidth connection. A request is received from the customer via a communications channel distinct from the high-bandwidth connection. The program to be recorded on the consumer device is determined based upon information received from the customer via the communications channel, and the consumer device associated with the customer is identified in response to the request. An instruction is then broadcast or otherwise transmitted to the consumer device associated with the customer via the high-bandwidth connection to thereby direct the consumer device to record the program requested by the customer.

In still other embodiments, a system is provided for distributing a plurality of instructions to a plurality of consumer devices associated with a plurality of customers via a high-bandwidth connection. The system includes an interface to a communications channel separate from the high-bandwidth connection, wherein the interface is configured to receive requests from the customers for actions to be carried out on the plurality of consumer devices. A processing system is configured to identify an identified one of the plurality of consumer devices for each of the receive requests, and to create an instruction for each of the received requests to direct the identified consumer device to carry out the action. An uplink control system configured to transmit the instructions to each identified consumer device via the high-bandwidth connection to thereby allow each identified consumer device to carry out the action requested by the customer.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a diagram of an exemplary system for remotely controlling a consumer device; and

FIG. 2 is a flowchart of an exemplary process for remotely controlling a consumer device.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

According to various embodiments, a customer is able to remotely control a set-top box (STB), personal video recorder (PVR), digital video recorder (DVR) and/or other consumer device from a telephone or other convenient terminal even though the controlled device is not directly accessible via a telephone or data network. In a telephone-based embodiment, for example, a customer places a telephone call to a service center and provides information that allows the service center to identify the particular device associated with the customer and the desired action to be taken. The service center is then able to transmit an instruction to the identified device over a high-bandwidth channel, such as the channel used to transmit programming content. In a satellite-based system, for example, an uplink station at the service center encodes the instruction to the consumer device in the content broadcast over the satellite link; a cable television system could similarly embed the instruction in a cable television signal distributed to various receiving devices. Other embodiments may allow the customer to provide inputs via other communications channels, such as via any sort of telephone, text message, data, Internet or other connection as appropriate. As a result, customers are able to remotely send instructions to a PVR/DVR, STB or other consumer device from a telephone, personal digital assistant, computer terminal, or other convenient access point as appropriate.

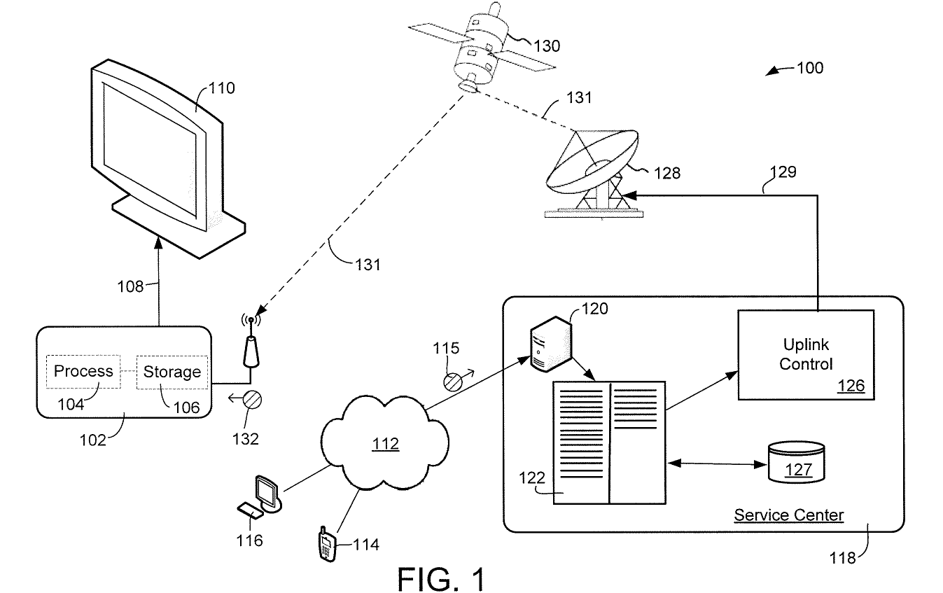

Turning now to the drawings figures and with initial reference to FIG. 1, an exemplary system 100 for remotely programming a consumer device 102 suitably allows customers to place requests 115 for actions via a telephone 114, computer system 116 or other node that is able to communicate with a service center 118 via any convenient communications channel 112. Service center 118 includes an interface 120 to communications channel 112 for receiving requests 115 from customers, as well as a processing module 122 that is able to identify particular consumer devices associated with customers placing requests 115. An uplink control system 126 associated with service center 118 transmits instructions 132 to the customer's device 102 via a high-bandwidth connection 131, which may be a satellite connection, cable connection and/or the like. Using this system 100, customers can conveniently place requests 115 to remotely control their consumer device 102 using any convenient communications channel 112, with ensuing instructions 132 being provided to the appropriate consumer device 102 via the high-bandwidth distribution channel 131. Customers can therefore remotely instruct a particular consumer device 102 to record a program, activate a parental control and/or take any other suitable action even though the device 102 is not connected to communications channel 112.

Consumer device 102 is any appliance or other device that is capable of receiving a high-bandwidth signal 131 and demodulating individual program signals 108 from signal 131 for viewing on display 110. In various embodiments, consumer device 102 is a set-top box or the like that typically includes a conventional processor 104, as well as a memory, hard disk or other storage device 106. Device 102 may incorporate digital and/or analog television demodulation features, PVR/DVR capabilities, video games or other entertainment features, and/or other capabilities as desired. In various embodiments, device 102 includes or communicates with any type of additional mass storage, including any sort of internal or external magnetic or optical hard drives, flash memory and/or the like. As used herein, the terms “personal video recorder (PVR)” and “digital video recorder (DVR)” are intended to be used synonymously as examples of consumer devices. In addition to describing devices capable of directly receiving high-bandwidth programming signals (e.g., television receivers and STBs), the phrase “consumer device” is intended to broadly encompass components or devices that may communicate with a set-top box or other device capable of receiving high-bandwidth programming signals in certain embodiments. As an example, an external PVR/DVR, place shifting device, disc player or other device may not itself directly receive instructions 132 via a high-bandwidth channel, but may instead interact or communicate with a television receiver, STB or other intermediary that is able to receive such instructions 132 and relay them to the end device. Such end devices could nevertheless be considered “consumer devices” as that term is intended in this document.

In addition to receiving programming signals 131 from a satellite 130 or other transmitter, consumer device 102 is generally able to receive instructions 132 from a service center 118 as appropriate. These instructions are generally contained within programming signals 131, and may be keyed to a unique code or other identifier associated with the particular device 102. Upon receiving an instruction in signal 131 that includes the device's identifier, then, device 102 is able to respond to individualized instructions from service center 118. Such instructions may be cryptographically encoded or otherwise protected to prevent tampering or other unauthorized behavior.

The particular instructions 131 may direct any sort of tasks or programming carried out by device 102. That is, device 102 may be able to process the instruction 132 using processor 104 and/or other resources as appropriate. In various embodiments, instructions 132 may direct device 102 to record a particular program, to set or release a parental control, to power on or off at any particular time, or to take any other appropriate action as desired by the customer. In various embodiments, instructions 132 include an identification of a program or other content to be recorded on a PVR/DVR associated with customer device 102. Instructions 132 may include an indication of the program such as a title, channel number, start and/or end time, program duration and/or other information as appropriate. In other embodiments, instructions 132 may simply indicate an entry in an electronic program guide (EPG) database that corresponds to the program to be recorded. Again, instructions 132 may direct any actions or programming on customer device 102 in any appropriate manner or format.

Service center 118 is any centralized or distributed data center, operations center, server or other central processor, and/or any combination thereof that is capable of receiving requests 115 from consumers and transmitting instructions 132 to consumer devices 102 as appropriate. In the exemplary embodiment shown in FIG. 1, service center 118 includes an interface 120 to a communications channel 112 that is separate from the high-bandwidth link 131, as well as a processing system 122 and an uplink control 126 as appropriate. In various embodiments, requests 115 received from consumers via interface 120 are used to generate instructions 132 transmitted to consumer devices 102 over the high-bandwidth link 131. Service center 118 may also contain a database 127 or other repository of information that can be used to associate customers with particular consumer devices 102, as described more fully below.

Interface 120 is any system, module or other logic capable of receiving requests 115 from various consumers via any communications channel 112. In various embodiments, communications channel 112 is any sort of telephone and/or data network, such as the Internet. Interface 120 therefore receives requests 115 via any type of telephone, text message (e.g., short message service (SMS)), email, web-based message, instant message and/or other communication as desired. In various embodiments, customers are able to generate and transmit requests 115 from any telephone 114, computer system 116, personal digital assistant, appliance and/or the like. Interface 120 may additionally incorporate a conventional call center function whereby a human or automated operator receives requests 115 via telephone, text message, email or any other medium, and enters the requests 115 into a computer system or the like for subsequent processing.

Processing system 122 suitably includes any sort of processing capability to produce electronic instructions 132 from received requests 115. Processing system 122 includes any sort of computing system, including appropriate hardware and/or software logic, for identifying a particular consumer device 102 associated with each request 115. In various embodiments, a database 127 includes information formatted in any appropriate manner that allows identifying information contained within request 115 to be correlated to a particular consumer device 102. Identifying information may include, for example, a telephone number or other address associated with a telephone or other device in the customer's possession. Such information may be obtained manually (e.g., may be typed in by the customer) or may be obtained using conventional caller-ID techniques to identify the customer transmitting a particular request 115. Alternatively, customers may provide a UserID/password combination, digital credential or other identifying information as appropriate. Such information may be initially obtained through any conventional registration process and/or may be based upon information already contained in a customer database maintained by a content aggregator or other party.

Processing system 122 may include hardware and/or software for executing any other actions as appropriate. In various embodiments, processing system 122 is able to determine an appropriate action to be executed by the identified consumer device 102, and/or to format or otherwise create an appropriate instruction 132 that can be transmitted to the consumer device 102 as appropriate. Processing system 122 may include call processing features, for example, for receiving inputs from a telephone call or other connection with the customers. In such embodiments, processing system 122 suitably provides menu options or other prompts to enable a customer to enter a program name, channel identifier, start/stop time, program identifier and/or other information as appropriate to identify programs to be recorded, or to take other actions as desired. In other embodiments, processing system 122 contains logic that is able to parse data contained within the request 115 (e.g., in the body of an email, text message or other datagram) to identify the desired action.

Instructions 132 may be formatted in any manner, and according to any temporal basis. In various embodiments, instructions 132 are formatted as data instructions that can be broadcast on high-bandwidth connection 131 by uplink control system 126. In various embodiments, uplink control system 126 contains scheduling and/or formatting logic that is able to create instructions 132 that can then be transmitted as a portion of the high-bandwidth link 131 to particular consumer devices 102 for execution. Uplink control system 126 further creates appropriate uplink signals 129 that include instructions 132 to particular devices 102. In a satellite-based embodiment such as that shown in FIG. 1, uplink signal 129 is typically provided to an antenna 128 that transmits the signal 131 to a geo-synchronous or other satellite 130. Satellite 130 then repeats the signal 131 toward the Earth for reception by the various consumer devices 102. Equivalent embodiments may use cable-based or terrestrial wireless distribution in place of satellite distribution.

In operation, then, system 100 allows a customer to remotely control a particular consumer device 102 (e.g., to record a program or take another action) using a convenient communications medium 112. The customer uses a telephone 114 or computer terminal 116, for example, to provide a request 115 to a service center 118 via a conventional telephone or network connection. Service center 118 receives the request 115 at interface 120, processes the request as appropriate, and transmits an instruction 132 to the customer's consumer device 102 via a high-bandwidth connection 131 that is distinct from the communications medium 112 used to transmit the original request.

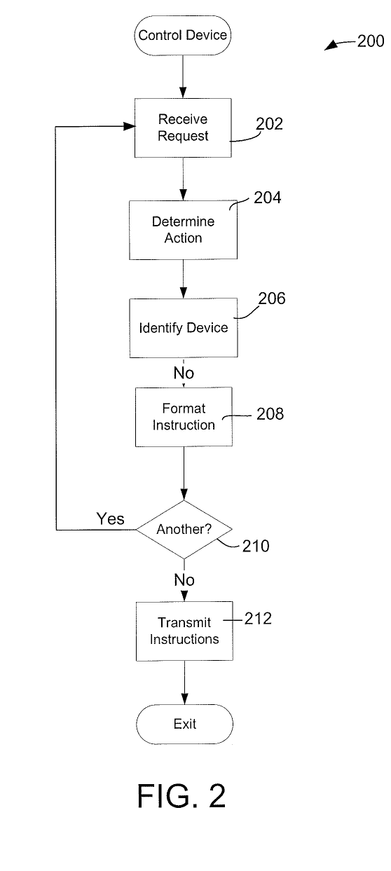

FIG. 2 provides additional detail about an exemplary method 200 for remotely controlling a consumer device 102. With reference now to FIG. 2, an exemplary method 200 suitably includes the broad steps of receiving a request 115 from the customer via a communications medium 112 (step 202), identifying the consumer device 102 associated with the customer (step 206), and transmitting an instruction 132 to the consumer device 102 via a high-bandwidth connection 131 distinct from the communications medium 112 used to place the original request (step 212). Method 200 may be implemented with any combination of manual and automatic processing. In various embodiments, method 200 may be implemented within the context of various processing devices or modules operating within service center 118 (FIG. 1) as appropriate. While much of method 200 may be implemented with general purpose computing hardware executing software or firmware in any language or format, some embodiments may incorporate elements of manual processing (e.g., data entry or the like) where appropriate to do so.

The exemplary method 200 shown in FIG. 2 begins with the receipt of a request 115 from a customer (step 202). As noted above, this request 115 may be placed via a telephone call, text message, internet message, datagram and/or the like. As such, step 202 may be carried out by any appropriate interface (e.g., interface 120 in FIG. 1) associated with a service center 118 or the like.

Upon receipt of a request from a customer, it is typically desirable to determine the particular action desired (step 204), and to identify the particular consumer device 102 that should execute the desired action (step 206). As noted above, the desired action can be determined in any manner. For example, the desired action may be determined by parsing the contents of an email, text message, datagram or the like. Alternatively, desired action can be determined though interaction with the customer in any manner. In embodiments wherein the customer's request 115 is provided in the context of a telephone call, for example, the desired action can be determined through interaction between the customer and a human operator and/or an automated data entry system. In the latter case, the customer may provide data to the automated system through keypad touches, voice recognition and/or any other technique.

Similarly, the consumer device 102 associated with the customer placing the request 115 may be determined in any manner (step 206). In some embodiments, the request 115 itself may contain sufficient information (e.g., an originating address or telephone number) to identify the customer. Alternatively, the customer can provide additional identifying information (e.g., userid/password combinations or other credentials as appropriate) to a human operator, automated data processing system, or other interface as appropriate. In either case, the identified customer can be associated with one or more consumer devices 102 using, for example, information stored in database 127 or the like.

As noted above, the various functions of steps 202, 204 and 206 may be combined or separated in any manner in various equivalent embodiments. A customer could send a request 115 as an an email or text message to a particular receiving address (or phone number), for example, with the content of the message specifying a title of a program to record (or any other identifier, such as a program identifier from an online guide or the like). In such an embodiment, the customer's particular consumer device 102 to be controlled could be identified by correlating the address or telephone number used to send request 115 to an identifier for the consumer device stored in database 127. In another embodiment, a customer contacts a call center via telephone, enters a personal identification number (PIN) or other code for identification, and then enters additional information via a keypad to further identify the program to be recorded or other action to be taken. Again, request 115 could be processed in any manner across a wide array of equivalent embodiments.

When the desired action and the particular consumer device 102 are identified, an appropriate instruction 132 can be formatted for the device in any manner (step 208). Formatting may involve generating appropriate commands and data parameters that can be understood by the particular consumer device 102, as well as processing any integrity checking, encryption and/or the like that may be appropriate. In various embodiments, multiple instructions 132 are aggregated in a queue or other structure for batch processing. Loop 210, for example, reflects that multiple requests 115 may be received and processed collectively so that instructions 132 for multiple consumer devices 102 are transmitted at a common time. Such a time may be assigned on any basis (e.g., hourly, half or quarter hourly, minute-by-minute, or any other basis). Alternatively, instructions 132 may be transmitted on link 131 when a queue fills or a threshold number of instructions are ready for transmit. In still other embodiments, instructions 132 are transmitted in real-time (or near real-time) to permit rapid implementation of customer requests.

Instructions 132 are therefore transmitted to the identified consumer devices 102 via the appropriate channel (step 212). As noted above, in some embodiments instructions may be broadcast or otherwise transmitted on the high-bandwidth channel 131 used to transmit television programming. Upon receipt of an instruction 132 with the device's identifying number, that device is able to extract the instruction 132 and carry out the desired action as appropriate.

Various systems and methods have therefore been described for remotely controlling an STB, PVR/DVR or other consumer device. While at least one exemplary embodiment has been presented in the foregoing detailed description, it should be appreciated that a vast number of alternate but equivalent variations exist. Although the systems and techniques described herein are frequently described with respect to satellite-based implementations, for example, similar concepts could be equivalently applied with cable, telephone, wireless and/or any other methods of content or message delivery. In an over-the-air embodiment, for example, instructions 132 could be equivalently transmitted in any broadcast channel (e.g., in an unused channel for a particular television market or geographic region), or in the unused bits (e.g., the so-called “user bits”) of an MPEG stream or any other portion of a digital or analog transmission. Instructions 132 could be equivalently transmitted on a separate carrier frequency across any wired or wireless media using any sort of radio frequency (RF) modulation scheme or the like.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method of remotely controlling a consumer device associated with a customer that is capable of receiving programming via a high-bandwidth connection, the method comprising:
receiving a request from the customer for an action to be taken by the consumer device, wherein the request is received via a communications channel distinct from the high-bandwidth connection;
identifying the consumer device associated with the customer in response to the request; and
transmitting an instruction to the consumer device associated with the customer via the high-bandwidth connection to thereby direct the consumer device to carry out the action requested by the customer.

2. The method of claim 1 wherein the transmitting comprises aggregating the instruction into a plurality of instructions commonly broadcast to a plurality of consumer devices over the high-bandwidth connection.

3. The method of claim 2 further wherein the identifying comprises obtaining an identifier for the consumer device associated with the customer, and wherein the instruction transmitted via the high-bandwidth connection comprises the identifier to thereby allow the consumer device associated with the customer to receive and execute the instruction based upon the identifier.

4. The method of claim 1 further comprising determining the action to be taken by the consumer device based upon information received from the customer via the communications channel.

5. The method of claim 4 wherein the communications channel is a telephone connection and wherein the determining comprises parsing the content of a text message sent via the telephone connection.

6. The method of claim 4 wherein the communications channel is a digital data connection and wherein the determining comprises parsing the content of a datagram sent via the digital data connection.

7. The method of claim 4 wherein the communications channel is a telephone connection and wherein the determining comprises receiving inputs from the customer via a telephone keypad.

8. The method of claim 7 further comprising prompting the customer to enter information via the telephone connection.

9. The method of claim 1 wherein the identifying comprises parsing a user identification and password combination contained within the request to thereby associate the customer with the consumer device.

10. The method of claim 1 wherein the identifying comprises parsing an identification number associated with a device transmitting the request to thereby associate the customer with the consumer device.

11. The method of claim 10 wherein the identifying information is a telephone number assigned to a telephone associated with the customer.

12. The method of claim 1 wherein the request is a request to program the consumer device to record a particular program transmitted to the consumer device via the high-bandwidth connection.

13. The method of claim 12 further comprising determining the particular program to record based upon information received from the customer via the communications channel.

14. A method of remotely directing a consumer device associated with a customer to record a program, wherein the consumer device is capable of receiving programming via a high-bandwidth connection, the method comprising:
receiving a request from the customer, wherein the request is received via a communications channel distinct from the high-bandwidth connection;
determining the program to be recorded on the consumer device based upon information received from the customer via the communications channel;
identifying the consumer device associated with the customer in response to the request; and
transmitting an instruction to the consumer device associated with the customer via the high-bandwidth connection to thereby direct the consumer device to record the program requested by the customer.

15. A system for distributing a plurality of instructions to a plurality of consumer devices associated with a plurality of customers via a high-bandwidth connection, the system comprising:
an interface to a communications channel separate from the high-bandwidth connection, wherein the interface is configured to receive requests from the customers for actions to be carried out on the plurality of consumer devices;
a processing system configured to identify an identified one of the plurality of consumer devices for each of the receive requests, and to create an instruction for each of the received requests to direct the identified consumer device to carry out the action; and
an uplink control system configured to transmit the instructions to each identified consumer device via the high-bandwidth connection to thereby allow each identified consumer device to carry out the action requested by the customer.

16. The system of claim 15 wherein each received request comprises identifying information that corresponds to information stored in a database to thereby allow the processing system to correlate identifying information in each received request to the identified one of the plurality of consumer devices.

17. The system of claim 16 wherein the uplink control system is further configured to broadcast the instructions to the plurality of consumer devices.

18. The system of claim 15 wherein the high-bandwidth connection is a satellite connection.

19. The system of claim 15 wherein the high-bandwidth connection is a cable television connection.

20. The system of claim 15 wherein the communications channel is selected from the group consisting of a telephone call, a text message, an email, a text message and a web-based message.
